(19) United States
(12) Patent Application Publication
(10) Pub. No.: US 2020/0402304 A1
(43) Pub. Date: Dec. 24, 2020

(54) ELECTRONIC DEVICE AND METHOD FOR MANAGING CUSTOM OBJECT ON BASIS OF AVATAR

(71) Applicant: Samsung Electronics Co., Ltd., Gyeonggi-do (KR)

(72) Inventors: Hoik HWANG, Gyeonggi-do (KR); Jiyoun KIM, Gyeonggi-do (KR); Ohyoon KWON, Gyeonggi-do (KR); Saebyuk SHEEN, Gyeonggi-do (KR); Jaehan LEE, Gyeonggi-do (KR); Junho CHOI, Gyeonggi-do (KR)

(21) Appl. No.: 16/975,337

(22) PCT Filed: Feb. 25, 2019
(86) PCT No.: PCT/KR2019/002291

§ 371 Date: Aug. 24, 2020

(30) Foreign Application Priority Data
Feb. 23, 2018 (KR) 10-2018-0022257

(51) Int. Cl. G06T 17/10; G06T 19/00; G06K 9/00

(52) U.S. Cl. CPC G06T 17/10; G06K 9/00315; G06K 9/00281; G06T 19/00

(57) ABSTRACT

An electronic device according to various embodiments may comprise: a display; a camera module; a memory; and a processor, wherein the processor is configured to obtain a selfie image, generate a user avatar on the basis of the obtained selfie image, reprocess the user avatar to generate at least one custom object interworking with applications of the electronic device, and while an application is executed, output the at least one custom object on a screen where the application is executed. Various other embodiments are also possible.

### TECHNICAL FIELD

Various embodiments of the disclosure relate to an electronic device and a method for operating an avatar-based custom object.

### BACKGROUND ART

In cyberspace, emoticons or stickers are used, instead of text, as communication assistant means. Emoticons or stickers are used as symbols to convey emotions, moods, and thoughts by using characters, letters, symbols, numbers, and the like. There is a problem in that an emoticon or sticker service needs to use an emoticon or sticker provided by a service provider including an independent third party or a designated application. According to the emoticon or sticker service, there is a limitation in using the same data as a tool for communication through various applications, and there is a disadvantage in that an emoticon or sticker desired by a user cannot be generated.

Meanwhile, an avatar, which denotes a user's alter ego, is a graphic character that stands in for the user, and is used in various fields other than games and chat services. Recently, with the improvement of graphics technology, research has been conducted to realistically reflect real features of users' appearances, movements, and the like to avatars in the virtual world.

### DISCLOSURE OF INVENTION

### Technical Problem

An embodiment of the disclosure is to provide a method and apparatus in which a user generates a user avatar using the user's selfie image and generate a custom sticker using the user avatar, and thus the custom sticker can be used in various applications.

An embodiment of the disclosure is to provide a method and apparatus in which a user's appearance change is analyzed by analyzing accumulated user's gallery images or a user avatar is updated by improving the accuracy of the user's feature points, and thus an optimized avatar and custom sticker resembling the user can be utilized.

### Solution to Problem

According to various embodiments, an electronic device may include a display, a camera module, a memory, and a processor, wherein the processor is configured to: acquire a selfie image; generate a user avatar based on the acquired selfie image; reprocess the user avatar to generate at least one custom object linked to applications of the electronic device; and output the at least one custom object to an application execution screen during executing of the application.

According to various embodiments, a method for operating an avatar-based custom object by an electronic device is provided. The method may include: acquiring a selfie image of a user; generating a user avatar based on the acquired selfie image; reprocessing the generated user avatar to generate at least one custom object linked to applications of the electronic device; and providing, to a user, the at least one custom object generated based on the user avatar in response to a request from the user during execution of an application of the electronic device.

### Advantageous Effects of Invention

According to various embodiments, a custom sticker resembling a user is used in various applications of an electronic device, and thus a user's personality can be reflected therein.

According to various embodiments, by learning a user's gallery image and updating the user's image with a user avatar and a custom sticker, the user recognition rate can be improved and a change in the state of the user can be more accurately reflected.

According to various embodiments, the appearance of a user avatar or sticker can be changed according to the occurrence of an event schedule or a condition in which an external environment changes, and thus may express various and special forms of states of a user as well as general emotions.

### BRIEF DESCRIPTION OF DRAWINGS

FIG. 1 is a block diagram illustrating an electronic device 101 in a network environment 100 according to various embodiments.

FIG. 2 is a block diagram 200 illustrating the camera module 180 according to various embodiments.

FIG. 3 illustrates the configuration of an electronic device and an external electronic device according to various embodiments.

FIG. 4 illustrates an avatar-based custom object operation method by an electronic device according to various embodiments.

FIG. 5 is an exemplary diagram illustrating an avatar-based custom object generation method by an electronic device according to various embodiments.

FIG. 6 is an exemplary diagram illustrating an avatar-based custom object operation method by an electronic device according to various embodiments.

FIG. 7 illustrates an avatar-based custom object operation method by an electronic device according to various embodiments.

FIG. 8 is an exemplary diagram illustrating an avatar-based custom object of an electronic device according to various embodiments.

FIG. 9 illustrates an example of the hierarchical structure of a custom object according to various embodiments.

FIG. 10 is an exemplary diagram illustrating avatar-based custom object operation by an electronic device according to various embodiments.

FIGS. 11 and 12 are exemplary diagrams illustrating avatar-based custom object by an electronic device according to various embodiments.

FIG. 13 is an exemplary diagram illustrating avatar-based custom object operation by an electronic device according to various embodiments.

FIG. 14 illustrates an avatar-based custom object operation method by an electronic device according to various embodiments.

FIG. 15 illustrates an avatar-based custom object operation method by an electronic device according to various embodiments.

FIG. 16 is an exemplary diagram illustrating an avatar-based custom object of an electronic device according to various embodiments.

FIG. 17 illustrates an avatar-based custom object operation method by an electronic device according to various embodiments.

FIG. 18 is an exemplary diagram illustrating avatar-based custom object by an electronic device according to various embodiments.

FIG. 19 illustrates an avatar-based custom object operation method by an electronic device according to various embodiments.

### MODE FOR THE INVENTION

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

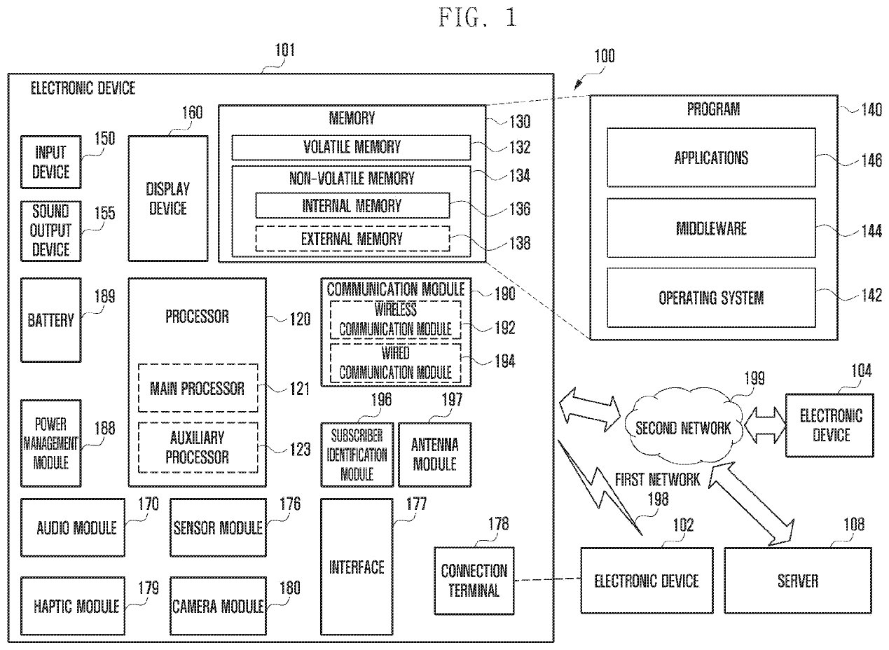

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

According to various embodiments, the processor 120 of the electronic device 101 may perform control to: generate a user avatar based on a selfie image designated by a user; reprocess the user avatar to generate a custom object linked to applications of the electronic device; and when an application of the electronic device 101 is executed, output the custom object to an application execution screen in response to a user request.

According to various embodiments, the processor 120 of the electronic device 101 may recognize a specific image area from a selfie image and thus extract a user's feature point (distinguishing feature). The processor 120 may generate avatar elements for generating an avatar, and may generate mapping elements mapped to a user image based on the feature point. The processor 120 may apply the avatar elements to a pre-stored basic face model to transform the basic face model into a 3D face shape, and may combine the 3D face shape with mapping elements to generate a user avatar having a 3D face shape. The feature point may include at least one of eyes, a nose, ears, a mouth, spots, scars, a beard, a face shape, a hairstyle, and a skin color. The mapping elements may include at least one of shape, shape information, location information, color information, length information, and width information of each feature point.

According to various embodiments, the processor 120 of the electronic device 101 may detect face elements and face outlines from the user avatar. The face element may include eyes, a nose, a mouth, ears, and unique elements (e.g., spots, a beard, glasses, etc.), and the face outlines may include facial lines and a hairline.

The processor 120 may apply the detected face elements and face outlines to a model according to each pose based on a pose set of a defined sticker format and thus change the model to an avatar form corresponding to each pose, and may generate a set of custom stickers into which the changed avatar form is inserted. The pose set having a sticker format may include at least one emotion pose, and may include a model corresponding to each emotion pose. The model may be used to change the shape of face elements and face outlines to a face shape corresponding to the emotion pose. For example, the model can be used to change the user avatar to match the pose of a sticker format corresponding to a facial expression, such as a smiley expression, a crying expression, or an angry expression.

The processor 120 of the electronic device 101 according to various embodiments may detect a condition in which an avatar-related event schedule or an external environment changes, and in response to the detected event schedule or external environment changing condition, may add an image corresponding to the event schedule or external environment changing condition to a custom object and generate an additional custom object. The processor 120 may provide the additional custom object in addition to a set of custom stickers, which have a sticker format and are generated when the application is executed.

The processor 120 of the electronic device 101 according to various embodiments may detect a difference change between a user image recognized by analyzing a gallery database DB and the generated user avatar, and may update a user avatar based on difference change information.

The processor 120 of the electronic device 101 according to various embodiments may identify the other person, who is recognized a defined number of times of frequency or more, in addition to a user, while analyzing the gallery DB, may generate at least one of an avatar and a custom sticker of the other person, and may transmit at least one of the generated avatar and custom sticker of the other person to the other person's electronic device (e.g., the external electronic device 104 of FIG. 1).

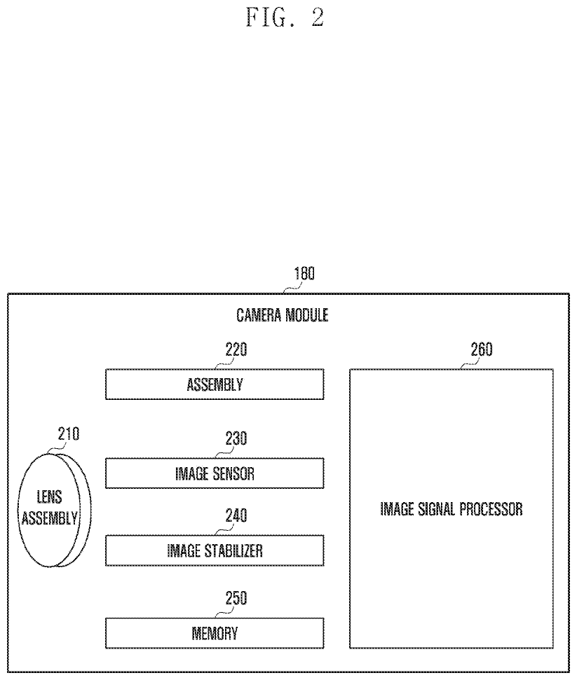

FIG. 2 is a block diagram 200 illustrating the camera module 180 according to various embodiments.

Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment, the image stabilizer 240 may sense such a movement by the camera module 180 or the electronic device 101 using a gyro sensor (not shown) or an acceleration sensor (not shown) disposed inside or outside the camera module 180. According to an embodiment, the image stabilizer 240 may be implemented, for example, as an optical image stabilizer. The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display device 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display device 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display device 160 as it is or after being further processed.

According to an embodiment, the electronic device 101 may include a plurality of camera modules 180 having different attributes or functions. In this case, for example, at least one of the plurality of camera modules 180 may be a wide-angle camera, and at least another one may be a telephoto camera. Similarly, one of the plurality of camera modules 180 may be a front-facing camera, and at least another one may be a rear-facing camera.

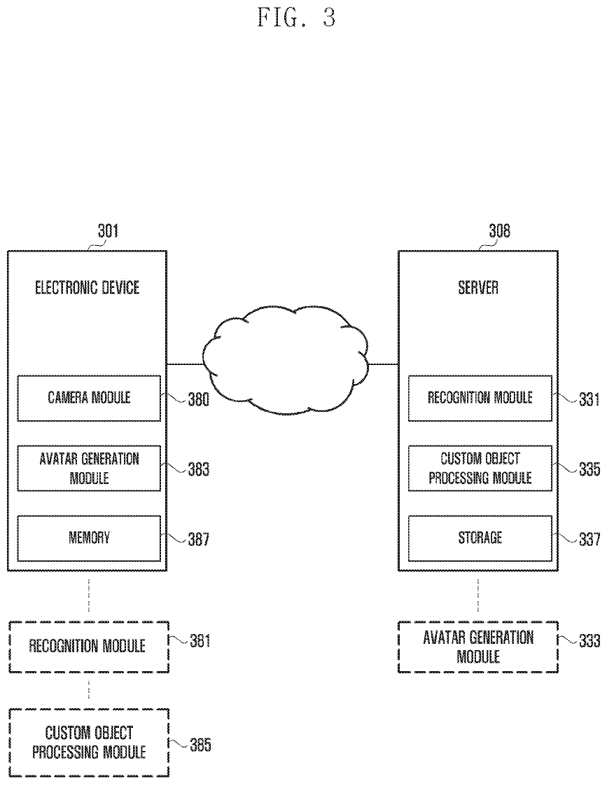

FIG. 3 illustrates the configuration of an electronic device and an external electronic device according to various embodiments.

Referring to FIG. 3, an electronic device 301 (e.g., the electronic device 101 of FIG. 1) according to various embodiments may include a camera module 380 (e.g., the camera module 180 of FIG. 1), an avatar generation module 383, and a memory 387.

Although not illustrated, the electronic device 301 may include a communication module (e.g., the communication module 190 of FIG. 1) that can transmit or receive data to or from an external electronic device 308. The external electronic device 308 may also include a communication module capable of transmitting or receiving data to or from the electronic device 101.

According to some embodiments, the electronic device 301 may further include a recognition module 381 and a custom object processing module 385, and the recognition module 381 and the custom object processing module 385 included in the electronic device 301 may be implemented as a processor (e.g., the processor 120 of FIG. 1). The recognition module 381 and the custom object processing module 385 of the electronic device 301 may be configured to perform the same function as at least some of the functions of the recognition module 331 and the custom object processing module 335 of the external electronic device 308. For example, the recognition module 381 of the electronic device 301 may be hardware configured to recognize a face in an image, and may be used to recognize a face more simply and quickly than the external electronic device 308 (e.g., the server 108) can. The custom object processing module 385 of the electronic device 301 may be used to generate a custom object from the generated avatar.

The external electronic device 308 (e.g., the electronic device 104 or the server 108 of FIG. 1) may include a recognition module 331, a custom object processing module 335, and a storage 337. The recognition module 331 may be a logic module or may be implemented as a processor of the external electronic device 308. The custom object processing module 335 may also be implemented as a processor of the external electronic device 308. According to an embodiment, the processor of the external electronic device 308 may perform both recognition and custom object processing.

In some embodiments, the external electronic device 308 may further include an avatar generation module 333. The avatar generation module 333 of the external electronic device 308 may be configured to perform the same functions as at least some of the functions of the avatar generation module 381 of the electronic device 301. The avatar generation module 333 of the external electronic device 308 may be used to generate a user avatar having higher similarity to a user face than that of a user avatar generated by the electronic device 301.

Images stored in the memory 387 of the electronic device 301 or acquired from the camera module 380, may be uploaded to the storage 337 of the external electronic device 308. The electronic device 301 and the external electronic device 308 may transmit or receive data related to a user avatar through a communication module.

In some embodiments, the electronic device 301 and the external electronic device 308 may operate in cooperation with each other to generate a user avatar and a custom object. Hereinafter, for convenience of explanation, subjects performing respective operations are described as being separately implemented. It is needless to say that the electronic device 301 and the external electronic device 308 may perform respective operations.

According to an embodiment, the recognition module 331 of the external electronic device 308 may recognize at least one image area by applying an object recognition algorithm or a texture recognition algorithm to the image area. The recognition module 331 of the external electronic device 308 may recognize at least one image area using various recognition algorithms, and may recognize at least one image area (e.g., a face) using a recognition algorithm obtained by applying machine learning or deep learning to the storage 337 (e.g., image storage). The recognition module 331 may recognize at least one object, for example, a face.

In some embodiments, image recognition information based on a recognition algorithm obtained by applying machine learning or deep learning may be provided to the electronic device 301.

According to an embodiment, the avatar generation module 383 of the electronic device 301 may be a logic circuit, and may be implemented as a processor (e.g., the processor 120 of FIG. 1) of the electronic device 301. The avatar generation module 383 may extract a user's feature point (distinguishing feature) from an image area which is recognized from an image, may generate an avatar element for generating an avatar, and may generate a mapping element mapped to a user image based on the feature point. The avatar generation module 383 may reflect the characteristics of the avatar element in a pre-stored basic face model to transform the basic face model into a 3D face shape. The avatar generation module 383 combines the 3D face shape with the mapping elements to generate a user avatar having a 3D face shape. The avatar generation module 383 may perform image processing so that the recognized user's face image and the generated user avatar image are similar to the user's real face. The avatar generation module 383 of the electronic device 301 may share the generated user avatar information with the external electronic device 308.

According to an embodiment, the custom object processing module 335 of the external electronic device 308 may detect face elements and face outlines from the user avatar. The face elements may include eyes, a nose, a mouth, ears, and unique elements (e.g., spots, beard, glasses, etc.), and the face outlines may include facial lines and a hairline. The custom object processing module 335 may apply the detected face elements and face outlines to a model according to each pose based on a pose set in a defined sticker format and thus change the model to an avatar form corresponding to each pose. The pose set having a defined sticker format may include at least one emotion pose, and the model may be used to change a shape of face elements and outlines to a shape corresponding to the emotion pose. The custom object processing module 335 may generate a custom sticker set including a plurality of stickers changed to a user avatar corresponding to each pose.

The custom object processing module 335 of the external electronic device 308 may detect a condition in which an avatar-related event schedule or an external environment changes, and in response to the detected event schedule or external environment changing condition, may add an image corresponding to the event schedule or external environment changing condition to a custom object and generate an additional custom object.

The custom object processing module 335 of the external electronic device 308 may detect a difference change between a user image, recognized by analyzing a gallery database (DB), and the generated user avatar, and may update a user avatar based on difference change information.

The custom object processing module 335 of the external electronic device 308 may share information related to avatar data processing and custom object data processing with the electronic device 301.

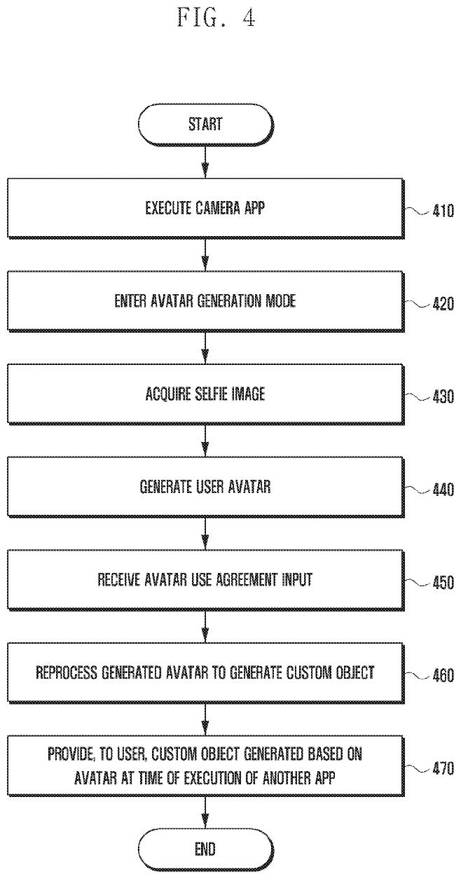

FIG. 4 illustrates an avatar-based custom object operation method by an electronic device according to various embodiments.

Referring to FIG. 4, a processor (e.g., the processor 120 of FIG. 1) of an electronic device (e.g., the electronic device 101 of FIG. 1 and the electronic device 301 of FIG. 3) according to an embodiment may execute a camera application (App) in response to a user's request for execution of a camera in operation 410. The processor 120 may output, to a display (e.g., the display device 160 of FIG. 1), as a preview image, an image obtained through a camera module (e.g., the camera module 180 of FIG. 1 and the camera module 380 of FIG. 3) according to the execution of a camera application.

In operation 420, the processor 120 may switch to an avatar generation mode in response to input requesting entering the avatar generation mode. According to an embodiment, the camera application may include menu items capable of switching to a camera function mode, which is supportable by the electronic device 101 or 301, for example, an avatar generation mode, a camera switching mode, and a video capture mode. The avatar generation mode may be a mode in which a front-facing camera is activated to acquire a user's selfie image.

In operation 430, the processor 120 may acquire a selfie image.

For example, in the case where a capture input request is received in the avatar generation mode, the processor 120 may capture a user's selfie image.

According to another example, the processor 120 may call a gallery app in response to input for calling the gallery app in the avatar generation mode, and may acquire a selected selfie image in the gallery app.

According to an embodiment, the processor 120 may configure, as an image for avatar generation, an automatically or manually acquired selfie image.

In operation 440, the processor 120 may generate a user avatar based on the acquired selfie image.

According to an embodiment, the processor 120 may recognize a face area and a hair area from the selfie image and extract a user's feature points (distinguishing feature) therefrom. The processor 120 may generate avatar elements for avatar generation from the selfie image, and may generate mapping elements mapped to a user image based on the feature points. The feature points may include at least one of eyes, a nose, ears, a mouth, spots, scars, a beard, a face shape, a hairstyle, and a skin color. The mapping elements may include at least one of shape, shape information, location information, color information, length information, and width information of each of feature points. The processor 120 may transform the pre-stored basic face model into a 3D face shape using the generated avatar element, and may combine the 3D face shape with mapping elements to generate a user avatar having a 3D face shape.

In operation 450, the processor 120 may output guide information indicating an agreement on avatar information use to a display (e.g., the display device 160 of FIG. 1), and may receive input of agreeing to avatar information use from a user. The avatar information use agreement may be an agreement on a use authority for generation of an avatar-based custom object (e.g., a sticker or emoticon) and for sharing of the custom object by another application.

In operation 460, the processor 120 may re-process the generated user avatar, in response to user input agreeing to avatar information use, to generate a custom object.

According to an embodiment, the processor 120 may detect face elements and face outlines from the user avatar, may change the shape of the avatar corresponding to each pose based on a pose set of a defined sticker format, and may generate a custom sticker object into which a user avatar is inserted or a set of such objects.

According to an embodiment, the custom object may be at least one sticker (or emoticon) to which a user avatar is applied. The custom object may be generated in the form of a set of a plurality of stickers expressing various emotions. The custom object may be configured such that a plurality of stickers containing the same pose are generated in various image format types. For example, the custom object may be generated as a first custom sticker generated in the form of a graphics interchange format (GIF) image format and a second custom sticker generated in the form of a portable network graphics (PNG) image format.

According to an embodiment, the processor 120 may transmit the generated user avatar to an external electronic device (e.g., the electronic device 108 of FIG. 1 and the external electronic device 308 of FIG. 3) through a communication module (e.g., the communication module 190 of FIG. 1).

According to another embodiment, the processor 120 may transmit the generated user avatar information to the external electronic devices 108 and 308, and may receive data relating to the custom object from the external electronic devices 108 and 308.

In operation 470, the processor 120 may provide, to an application execution screen, a custom object generated based on the user avatar at the request of a user during execution of the application of the electronic device 101 or 301.

According to an embodiment, the processor 120 may be configured to link the generated custom object to another application. The processor 120 may additionally configure a custom object in a keypad layout, called to the highest layer, such as a keypad. The processor 120 may additionally configure an item for calling a custom object in a menu item for calling a gallery or video in the application execution screen.

According to various embodiments, the processor 120 may configure a user avatar as a user profile and change avatar information of an application related to the user profile to the user avatar.

According to various embodiments, the processor 120 may receive user input of requesting calling a custom object at the time of execution of the application, and may call a generated custom sticker on an application screen being executed, in response to reception of user input. For example, in the case where the user selects a custom object call menu added to the keypad or the emoticon window at the time of execution of the message application, the processor 120 may output a set of custom stickers to a message application screen. In the case where the user selects one custom sticker in the list of custom stickers, the processor 120 may transmit the selected sticker to the external electronic devices 108 and 308 in response to a transmission request from the user.

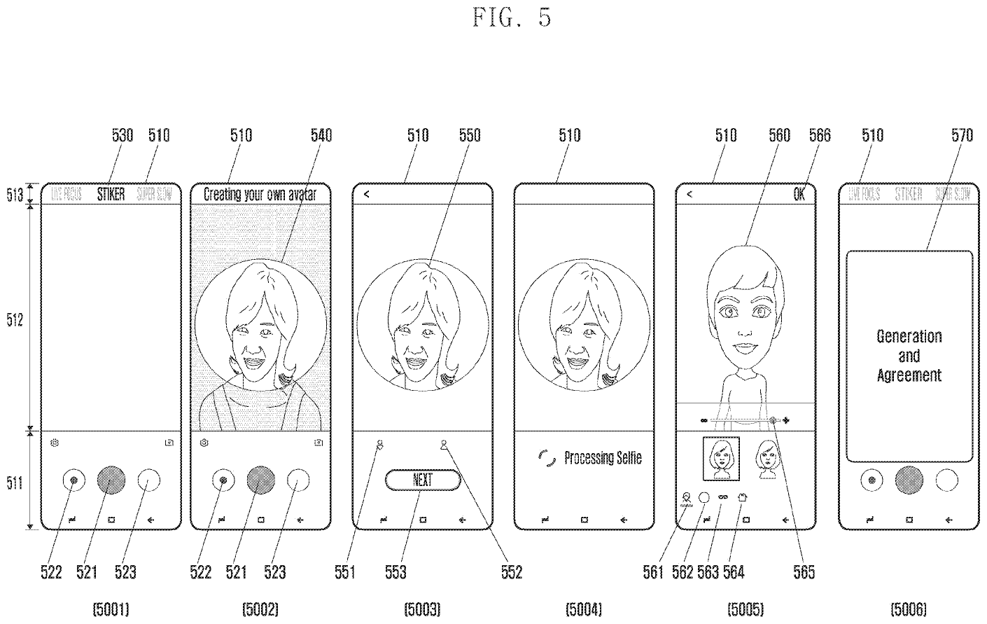

FIG. 5 is an exemplary diagram illustrating an avatar-based custom object generation method by an electronic device according to various embodiments.

Referring to FIG. 5, according to various embodiments, a user may execute a camera application of an electronic device (e.g., the electronic device 101 of FIG. 1 or the electronic device 301 of FIG. 3) and enter an avatar generation mode.

In response to the user's request for execution of a camera application, a processor (e.g., the processor 120 of FIG. 1) of an electronic device (the electronic devices 101 or 301 of FIG. 1) may output a camera execution screen 510 to a display (e.g., the display module 160 of FIG. 1) as shown in <5001>. The camera execution screen 510 may include a menu area 511 for execution of a camera function, a preview area 512 in which a preview image is displayed, and a mode-switching area 513. The menu area 511 may include at least one of a capture button item 521, a video button item 522, and a gallery call item 523, but is not limited thereto. In <5001>, the mode-switching area 513 is illustrated as being located on the top of the preview area 512, but the location may differ according to the screen arrangement, and thus arrangement thereof may differ depending on the configuration.

The user may select an avatar generation mode item 530 from among items in the mode-switching area 513. The processor 120 may enter the avatar generation mode and switch to a front-facing camera mode in order to acquire a selfie image, as shown in <5002>. In the avatar generation mode, a face guide line 540 for improving accuracy of recognition of the user's face may be output to the display 160.

The user may select a capture button item 521 in order to acquire the user's selfie image. In response to the selection of the capture button item 521, the processor 120 may capture an image of the user using the camera module (e.g., the camera module 180 of FIG. 1 and the camera module 380 of FIG. 3) so as to acquire a selfie image 550, as shown in <5003>.

According to another embodiment, the user may skip the capture operation after entering the avatar generation mode, select a gallery call item 523, and then call the user's selfie image stored in the gallery. In this case, a selfie image having a face size corresponding to the face guide line may be referred to as the user's selfie image.

In <5003>, the processor 120 may output gender selection items 551 and 552 for avatar generation.

The user may select a gender item, for example, a female item 551 in order to generate an avatar, and may select a “next” item 553. Then, the processor 120 may process data so that an avatar having the selected female gender is generated, and may output information indicating that the data is being processed, as shown in <5004>.

The processor 120 may output a user avatar output screen, as shown in <5006>, after completion of data processing, which is performed to generate a user avatar having characteristics similar to a user's face based on an image of the user. The user avatar output screen may output at least one of edit items for editing an avatar, for example, items 561, 562, 563, and 564 for changing hair, hair color, accessories, and clothes, respectively, and an item 565 for adjusting the avatar size.

The user may change the appearance of the generated user avatar using the edit items displayed on the screen. The appearance may include at least one of hair, accessories, clothes, and skin color, and the appearance may be provided in a defined format.

The user may select a check item 566 and store the generated avatars in the electronic device 101 or 301.

In response to selection of the check item 566, the processor 120 may output an avatar information use agreement guide screen, as shown in <5007>. Information 570 for guiding configuration of a use authority for generation of a user avatar-based custom object (e.g., a sticker or emoticon) and for sharing with another application may be displayed on the avatar information use agreement guide screen.

According to an embodiment, upon completion of the avatar generation, the processor 120 may automatically generate a custom object based on the user avatar, and may configure the generated custom object to be linked to another application.

According to another embodiment, although not shown in the drawing, the processor 120 outputs an agreement item and a non-agreement item to the avatar information use agreement guide screen, and in the case where input for selecting the agreement item is received, the processor 120 may generate a custom object, and may configure the generated custom object to be linked to another application.

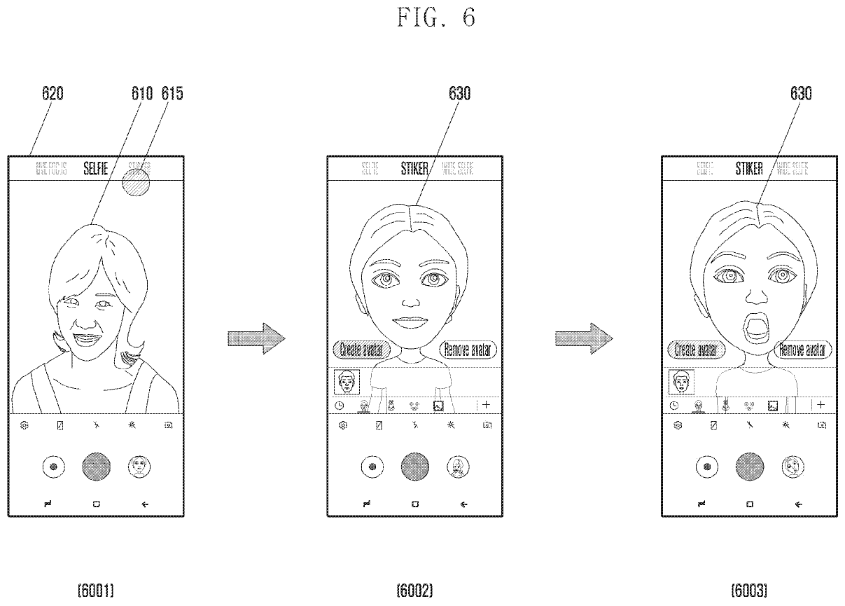

FIG. 6 is an exemplary diagram illustrating an avatar-based custom object operation method by an electronic device according to various embodiments.

Referring to FIG. 6, according to various embodiments, an electronic device (e.g., the electronic device 101 of FIG. 1 or the electronic device 301 of FIG. 3) may reflect a user's facial expression and behavior in real time using a user avatar in a camera application and support a function of recording the user's facial expression and behavior.

As illustrated in <6001>, the user may execute the camera application and photograph the user himself or herself to output the selfie image 610 to a camera app screen 620. The user may select an avatar generation mode item 615 to request avatar generation.

As shown in <6002>, the processor (e.g., the processor 120 of FIG. 1) may output a generated user avatar 630 to the camera app screen 620. At this time, the processor 120 may maintain execution of the camera and continuously acquire a preview image of the user.

The processor 120 may analyze the user's preview image in parallel in the state in which the user avatar is displayed on the camera execution screen 620, and may perform an operation of recognizing gesture changes, such as movement changes and facial expression changes, from the user's preview images.

The user may perform an action of opening his or her mouth or moving his or her head. Then, as shown in <6003>, the processor 120 may reflect the recognized gesture change to the user avatar so as to perform control such that the user avatar, displayed on the camera execution screen 620, is changed in real time according to the user movement. The user may capture a video in which the face shape of the user avatar 630 changes according to the user's movement in the camera capturing mode.

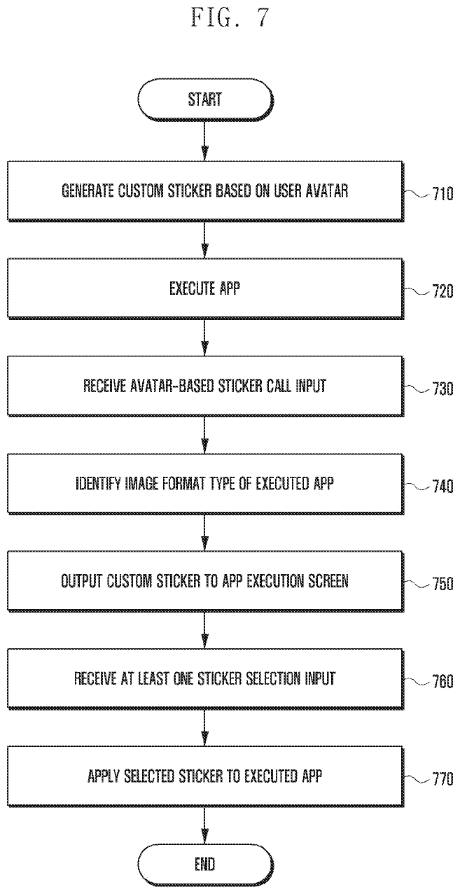

FIG. 7 illustrates an avatar-based custom object operation method by an electronic device according to various embodiments.

Referring to FIG. 7, a processor (e.g., the processor 120 of FIG. 1) of an electronic device (e.g., the electronic device 101 of FIG. 1 or the electronic device 301 of FIG. 3) according to various embodiments may generate a custom sticker based on a user avatar, in operation 710. At the time of generation of the custom sticker, the processor 120 may configure a use authority such that the custom sticker is used in another application.

In operation 720, the processor 120 may execute an application (app) of the electronic device according to an app execution request from a user. Here, the application may be a text-based application, such as a message, a memo, or a schedule, a social network service-based application, a gallery application, or a photo application, but is not limited thereto.

In operation 730, the processor 120 may receive input of calling a custom sticker in the executed application. For example, the processor 120 may receive an input for selecting a custom sticker call item included in a keypad menu or an emoticon call menu on the application screen.

According to an embodiment, in operation 740, the processor 120 may identify an image format type available in the executed app, and may output a custom sticker generated in the identified image format type in operation 750. In some embodiments, operation 740 is omitted, and operation may proceed to operation 750 from operation 730.

In operation 750, the processor 120 may output a custom sticker to the app execution screen. For example, the processor 120 may output a custom sticker set having various poses to a schedule application screen in a pop-up form, an overlay form, or a screen split form.

In operation 760, the processor 120 may receive a user input for selecting at least one sticker in the output custom sticker set. In operation 770, the processor 120 may apply the selected sticker to the executed app. For example, the processor 120 may insert and store a sticker, selected by the user, in a specific schedule at the time of recording the schedule in the schedule application.

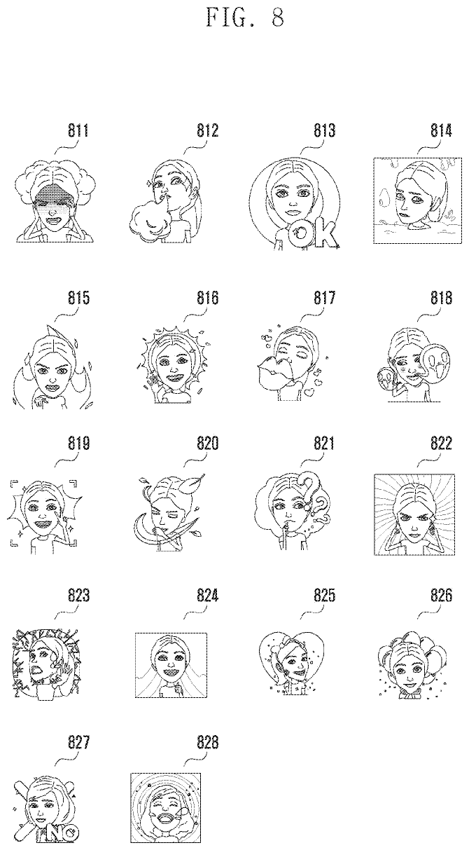

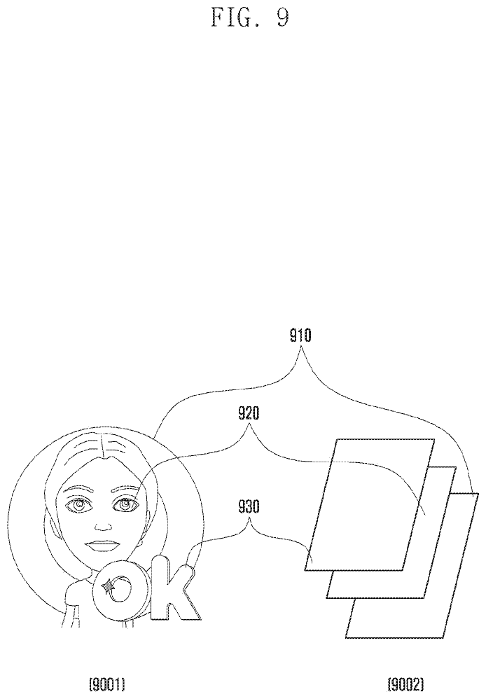

FIG. 8 is an exemplary diagram illustrating an avatar-based custom object of an electronic device according to various embodiments, and FIG. 9 illustrates an example of the hierarchical structure of a custom object according to various embodiments.

Referring to FIG. 8, an electronic device (e.g., the electronic device 101 of FIG. 1 and the electronic device 301 of FIG. 3) according to various embodiments may support the generation of various types of custom stickers.

A set of custom stickers may be generated based on a pose set in a defined sticker format. The pose set may be a set capable of expressing at least 18 emotions, but is not limited thereto. The pose set of the sticker format can be changed in various forms, and the number of poses is not limited thereto.

According to an embodiment, the set of custom stickers, as shown in FIG. 8, may be generated as stickers that can express emotions, such as stressful 811, sulky 812, okay 813, sadness 814, angry 815, hello 816, kiss 817, relieved 818, V mark 819, weary 820, thinking 821, concentration 822, fearful 823, best 824, pretty 825, smile/happy 826, negative 827, laugh 828, etc., but stickers expressing other emotions may also be generated.

According to various embodiments, the processor 120 of the electronic device may change face elements (eyes, a nose, a mouth, ears, and unique elements (e.g., spots, beard, glasses, etc.) and facial outlines in a model corresponding to each emotional pose and reflect the changed face elements and facial outlines for application to the user avatar. To this end, the custom sticker may be produced in a three-layer form. As shown in FIG. 9, the case of comparing a sticker object 9001 with a hierarchical structure 9002, a background image may be generated as a first layer 910, a user avatar may be generated as a second layer 920, and a text image may be generated as a third layer 930, differently from each other. The processor 120 may generate various types of custom sticker sets by replacing data of the second layer with user avatar data generated based on the selfie image.

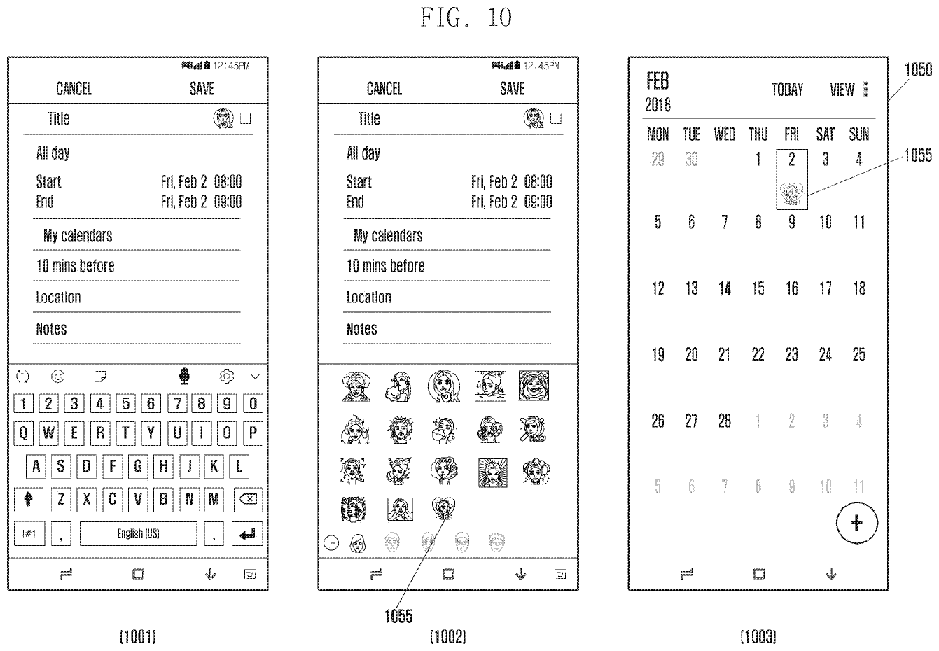

FIG. 10 is an exemplary diagram illustrating avatar-based custom object operation by an electronic device according to various embodiments.

Referring to FIG. 10, according to various embodiments, an electronic device may provide support such that a custom object is to be used in a schedule application.

The processor (e.g., the processor 120 of FIG. 1) of the electronic device (e.g., the electronic device 101 of FIG. 1 and the electronic device 301 of FIG. 3) may execute a schedule application in response to a user's execution request. In the case where the user selects a specific day in order to record a specific day, the processor 120 may output a schedule recording screen as shown in <1001>. On the schedule recording screen 1010, the user may select a text input window 1015 to call a keypad 1020.

According to an example, in the case where the user selects an emoticon item 1025 on the keypad to call a custom sticker, the processor 120 may output a custom sticker set 1030 to the schedule recording screen 1010, as shown in <1002>.

According to another example, if a sticker call item 1040 included in the schedule record screen 1010 is selected, the processor 120 may output a custom sticker set 1030 to the schedule record screen 1010 without calling the keypad.

The user may select one sticker in the output custom sticker set and request to finish the schedule recording. The processor 120 may store the schedule by inserting a selected custom sticker 1055 into a specific day, as shown in <1003>, in response to the request to finish.

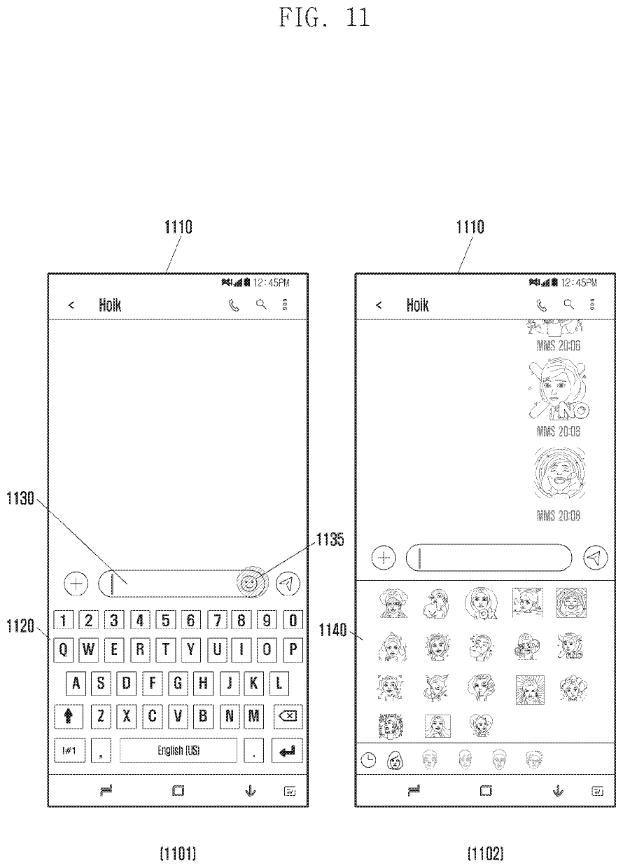

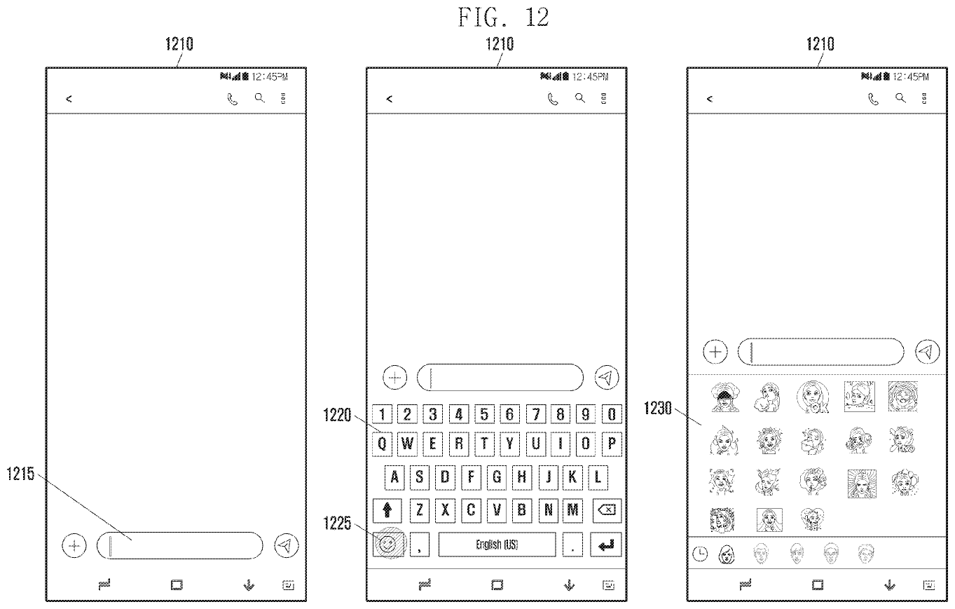

FIGS. 11 and 12 are exemplary diagrams illustrating avatar-based custom object by an electronic device according to various embodiments.

Referring to FIGS. 11 and 12, according to various embodiments, an electronic device (e.g., the electronic device 101 of FIG. 1 and the electronic device 301 of FIG. 3) may provide support such that a custom object is to be used in a message application or a social network-based application.

According to an embodiment, the processor 120 may execute a message application in response to a message execution request, and may output a message app screen 1101 to a display (e.g., the display device 160 of FIG. 1), as shown in <1101>. Since the message app corresponds to an application built in the electronic device 101 or 301, a custom sticker item may be added to an emoticon menu and provided to the user. The user may call the custom sticker by selecting an emoticon item 1135 of a text input window 1130 on the message app screen 1101. As shown in <1102>, the processor 120 may output a custom sticker set 1140 on the message app screen.

According to an embodiment, the user may request execution of a social network-based application. A social network service-based application may be an application provided by a service provider including a third party. The processor (e.g., the processor 120 of FIG. 1) of the electronic device 101 or 301 may execute the social network-based application in response to an execution request and output a social network-based application screen 1210 to a display (e.g., the display device 160 of FIG. 1), as shown in FIG. 12.

The user may select a text input window 1215 for calling a keypad. The processor 120 may call a keypad 1220 in the social network-based application screen 1210 as shown in FIG. 12, and the user may select an emoticon item 1225 on the keypad to call a custom sticker. The processor 120 may output a custom sticker set 1230 on the social network-based application screen 1210, as shown in FIG. 12.

Thereafter, the user may select one sticker in the output custom sticker set and select a transmission item. Then, the processor 120 may transmit a sticker selected by the user to the other party's electronic device.

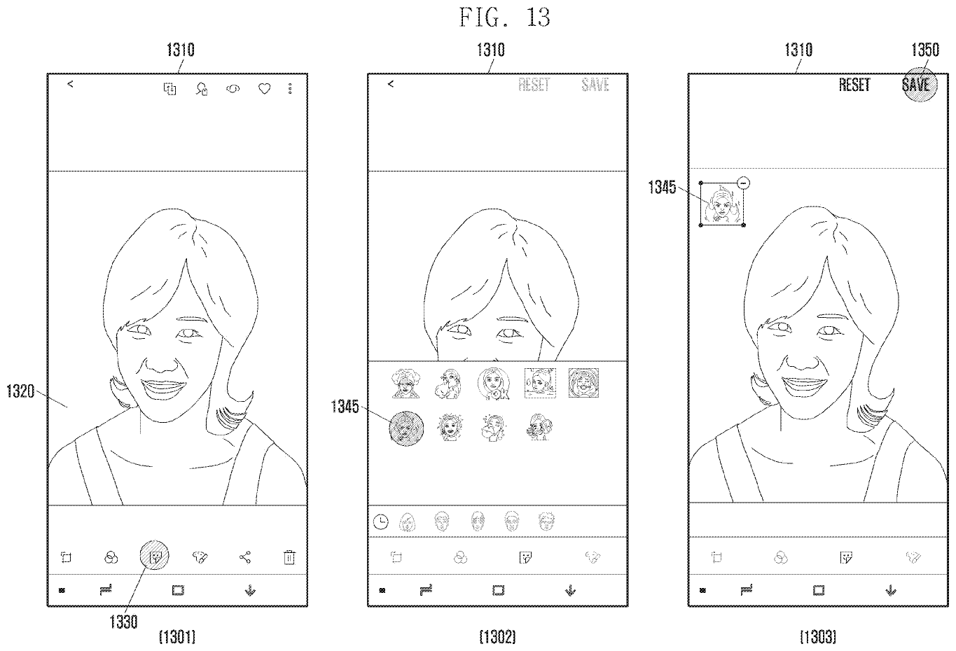

FIG. 13 is an exemplary diagram illustrating avatar-based custom object operation by an electronic device according to various embodiments.

Referring to FIG. 13, according to various embodiments, a processor (e.g., the processor 120 of FIG. 1) of an electronic device (e.g., the electronic device 101 of FIG. 1 and the electronic device 301 of FIG. 3) may provide support such that a custom object is to be used in a gallery and a video-editing application.

The user may request execution of an application for editing a gallery or video. The processor 120 may execute the editing application in response to an execution request and output an edit app screen 1310 to a display (e.g., the display device 160 of FIG. 1).

The user may call an image or video 1320 to be output to the display in order to perform editing. The user may call a custom sticker by selecting a sticker call item 1330 included in an edit app screen 1310. Then, the processor 120 may output a custom sticker set 1340 on the image or video 1320 output on the edit app screen 1310, as shown in <1302>.

In the case where the user selects one sticker 1345 in the output custom sticker set 1340, as shown in <1303>, the processor 120 may add the selected sticker 1345 onto the image displayed on the screen. Thereafter, in the case where the user selects a storage item 1350, the processor 120 may store an edited image having a sticker added thereto.

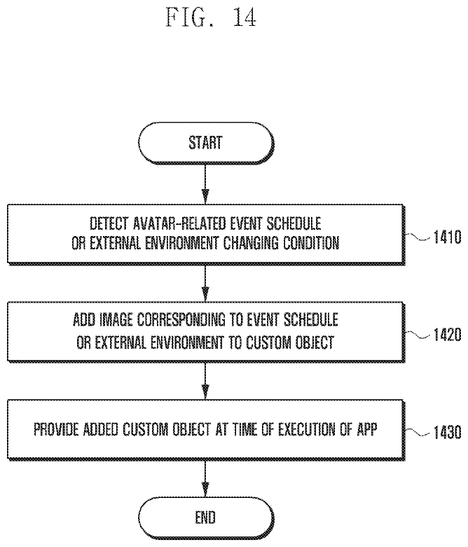

FIG. 14 illustrates an avatar-based custom object operation method by an electronic device according to various embodiments.

Referring to FIG. 14, according to various embodiments, in operation 1410, a processor (e.g., the processor 120 of FIG. 1) of an electronic device (e.g., electronic device 101 of FIG. 1 or the electronic device 301 of FIG. 3) may detect a condition in which an avatar-related event schedule or an external environment changes.

According to an embodiment, the processor 120 may identify whether an event schedule exists based on information of a schedule application. The event schedule may be at least one of New Year's Day, Christmas day, Chuseok, Valentine's Day, a birthday, and an anniversary, but is not limited thereto, and various event schedules may be included therein.

According to an embodiment, the processor 120 may identify whether the current weather has changed or the season has changed based on weather information.

In operation 1420, the processor 120 may generate a new custom object by adding an additional image corresponding to the event schedule or external environment changing condition to a custom object in response to the detected event schedule or external environment changing condition. The additional image may be an image of a background layer of a custom object or an image of a text layer, but is not limited thereto.

For example, if January 6 is the user's birthday, the electronic device may identify that January 6 is the user's birthday, and may generate a custom object corresponding to the birthday image.

In operation 1430, the processor 120 may provide the additional custom object in addition to the custom sticker set in a defined sticker format at the time of execution of the application. For example, if the user's custom object call input is received, on January 6, the electronic device may provide a custom object corresponding to the birthday image, in addition to the defined sticker format-based custom sticker set.

According to another embodiment, the processor 120 may be configured such that January 6 is identified to be a birthday by an additional custom object generated based on a specific schedule and a birthday sticker is automatically provided to a schedule application on January 6.

According to another embodiment, the processor 120 may identify that, due to the detection of the external environment changing condition, the external environment has been changed in the case of raining or snowing or when the season changes, and may generate a new custom object based on an image corresponding to rain, an image corresponding to snow, and an image corresponding to each season. In the case of snow, the electronic device may generate a new custom object related to the weather based on a background image of the snow and a text image representing the snow, and may provide the new custom object to the user.

According to another embodiment, the processor 120 may change the background image of a user avatar so as to reflect the external environment change to the user avatar, configured as a user profile, as well as the custom object according to the external environment changing condition.

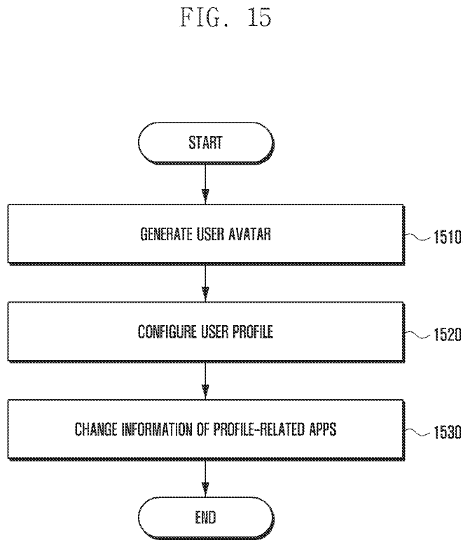

FIG. 15 illustrates an avatar-based custom object operation method by an electronic device according to various embodiments.

Referring to FIG. 15, according to various embodiments, a processor (e.g., the processor 120 of FIG. 1) of an electronic device (e.g., the electronic device 101 of FIG. 1 or the electronic device 301 of FIG. 3) may generate an avatar in operation 1510.

In operation 1520, the processor 120 may configure the generated avatar as a user profile.

According to an embodiment, at the time of generation of the avatar, the processor 120 may output guide information for identifying whether the generated avatar is configured as a user profile. In the case where approval input for configuring the generated avatar as the user profile is received from the user, the processor 120 may store the generated user avatar as the user profile.

In operation 1530, the processor 120 may change information of applications related to the profile in response to a user profile configuration. For example, the processor 120 may change a profile, configured by default in a contact application, to the generated user avatar. The user avatar, which is changed to the user profile, can be used in a call application, a message application, and a social network-based application.

According to an embodiment, the electronic device may support calling a user avatar by a user by adding a user avatar call item to a gallery call item at the time of configuring a user profile in a social network-based application. The user may call a user avatar in a social network-based application or an application capable of configuring an avatar, and may designate the user avatar for the user profile.

According to an embodiment, the electronic device may transmit the configured user avatar to the other party's electronic device at the time of execution of a call application. Then, the user avatar transmitted from the electronic device may be output to a call screen of the other party's electronic device.

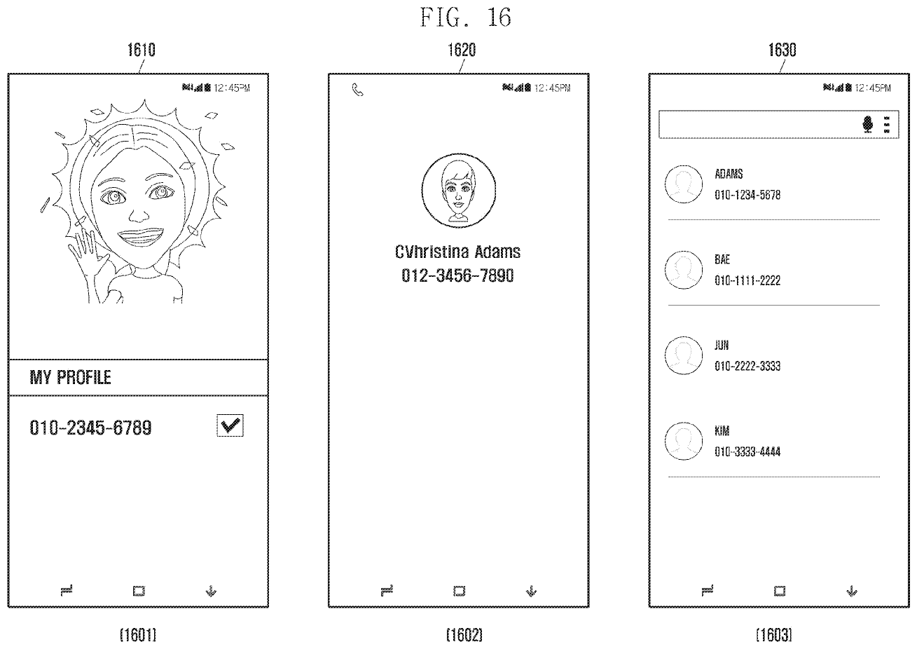

FIG. 16 is an exemplary diagram illustrating an avatar-based custom object of an electronic device according to various embodiments.

Referring to FIG. 16, an electronic device according to various embodiments may provide support such that a user profile is configured using a custom sticker. For example, as shown in <1601>, one custom object, which is generated based on a user avatar according to the configuration request by a user, as well as the user avatar, may be configured in a user profile screen 1610.

A processor (e.g., the processor 120 of FIG. 1) of an electronic device (e.g., the electronic device 101 of FIG. 1 or the electronic device 301 of FIG. 3) according to various embodiments may generate multiple custom stickers having the same pose in various image format types, and may provide support such that custom stickers of a suitable image format according to the type of application are used.

For example, the processor 120 may generate a custom object as a first custom sticker generated in the form of a graphics interchange format (GIF) image format and a second custom sticker generated in the form of a portable network graphics (PNG) image format, but is not limited thereto. The electronic device may generate a custom sticker in another image format supported by an application installed in the electronic device, in addition to GIF and PNG.

The electronic device may be configured to identify image format types available in an application executed at the request of a user, and to provide an execution application with a custom sticker in an image format corresponding to the image format type.

For example, as shown in <1602>, in the case of a call application screen 1620, a custom sticker generated in the GIF image format may be applied.

As shown in <1603>, in the case of a contact application screen 1630, a custom sticker generated in a GIF image format or a PNG image format may be applied. In another example, in the case of a schedule application screen, a custom sticker generated in the PNG image format may be applied.

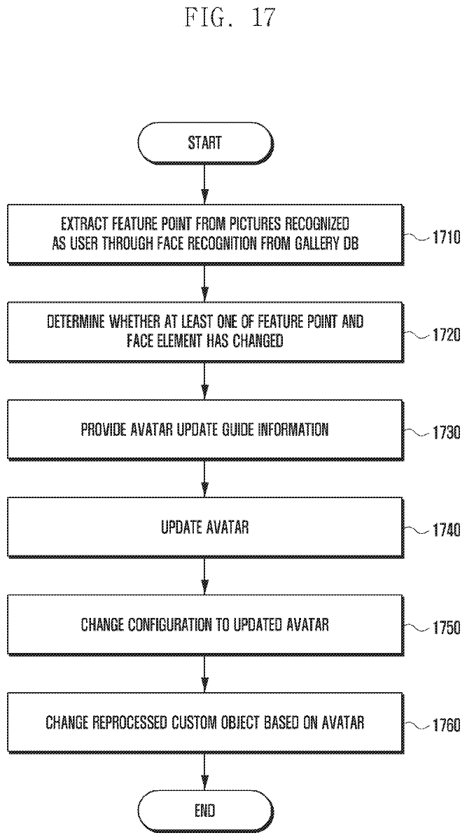

FIG. 17 illustrates an avatar-based custom object operation method by an electronic device according to various embodiments.

Referring to FIG. 17, according to various embodiments, in operation 1710, a processor (e.g., the processor 120 of FIG. 1) of an electronic device (e.g., the electronic device 101 of FIG. 1 or the electronic device 301 of FIG. 3) may perform face recognition in the gallery database to select images recognized as a user.

In operation 1720, the processor 120 may determine, from the selected images, whether at least one of feature points and face elements has been changed. The feature points may include at least one of eyes, a nose, ears, a mouth, spots, scars, a beard, face shape, hair, and a skin color.

According to an embodiment, the processor 120 may compare the recognized feature points using a recognition algorithm obtained by applying machine learning or deep learning to determine whether the feature point has changed.

According to an embodiment, the processor 120 may detect changes in the face elements and the face outlines from a user image to determine whether a change in the user's state is detected. The face elements may include eyes, a nose, a mouth, ears, and unique elements (e.g., spots, beard, glasses, etc.), and the face outlines may include facial lines and a hairline.

In operation 1730, the processor 120 may display, on the display screen, guide information about whether to perform avatar update in the case where a change in a feature point or a change in the user's state occurs.

In operation 1740, in the case where the processor 120 receives input agreeing to the avatar update from the user, the processor 120 may update the avatar by changing the avatar based on change information. In operation 1750, the processor 120 may change the configuration using the updated user avatar.

In operation 1760, the processor 120 may change the reprocessed custom object based on the updated user avatar.

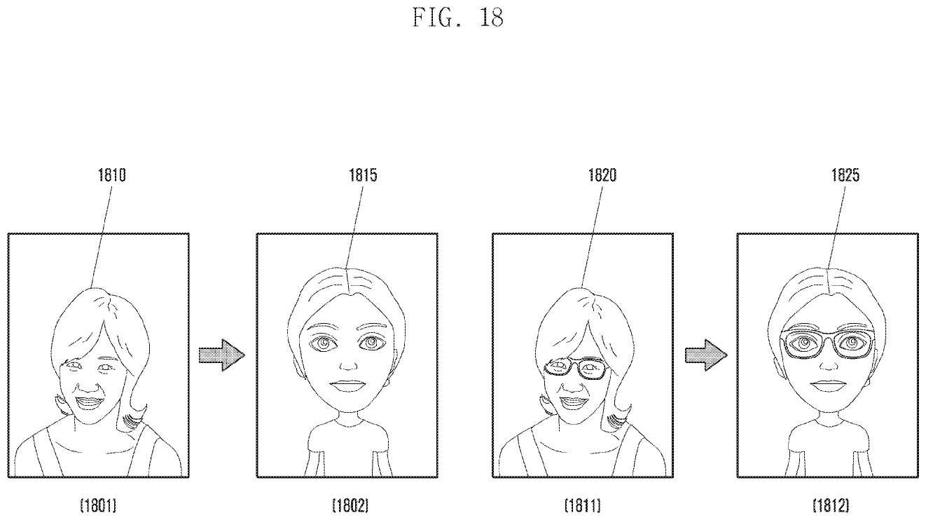

FIG. 18 is an exemplary diagram illustrating avatar-based custom object by an electronic device according to various embodiments.

Referring to FIG. 18, according to various embodiments of the disclosure, a processor (e.g., the processor 120 of FIG. 1) of an electronic device (e.g., the electronic device 101 of FIG. 1 or the electronic device 301 of FIG. 3) may, when a difference occurs between a user image recognized by analyzing the gallery database and the generated user avatar, recognize the difference therebetween, and may provide support to apply the difference to the user avatar.

According to an embodiment, the processor 120 may generate a user avatar 1815, which is generated based on a user image 1810 in <1801>, in the form shown in <1802>. The processor 120 may recognize that the state of the user's face elements has been changed to a form of wearing glasses accessory, as shown in <1811>, in the middle of analyzing the gallery database. The processor 120 may recognize the state change of the face elements, recognize the glasses accessory, and generate the user avatar 1815 as a user avatar 1825 wearing glasses in the form shown in <1812>.

According to an embodiment, the processor 120 may be configured to update the user avatar in the case where a defined condition, such as a condition in which the most recent image occurs within a predetermined period of time and a condition in which a state change is repeated the predetermined criterion or more, is satisfied. Accordingly, it is possible to solve the problem of repeatedly implementing user avatar update according to the single occurrence of state change.

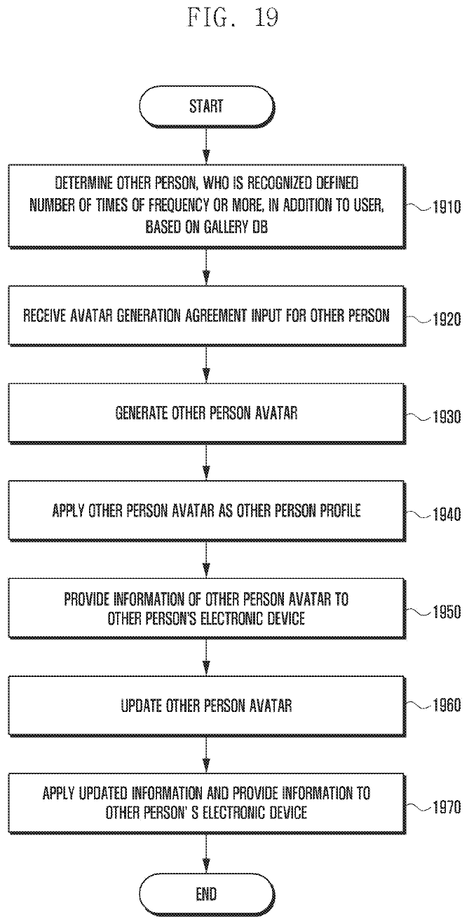

FIG. 19 illustrates an avatar-based custom object operation method by an electronic device according to various embodiments.

Referring to FIG. 19, a processor (e.g., the processor 120 of FIG. 1) of an electronic device (e.g., the electronic device 101 of FIG. 1 or the electronic device 301 of FIG. 3) according to various embodiments may identify the other person, who is recognized a defined number of times of frequency or more, in addition to a user, based on the analysis of a gallery database, in operation 1910.

In operation 1920, the processor 120 may output, through the display, guide information notifying of whether to agree to the generation of other person avatar. In operation 1930, in the case of receiving input agreeing to the generation of the other person's avatar, the processor 120 may generate the other person's avatar based on the other person's image recognized in the gallery.

In some embodiments, the processor 120 may generate the other person's avatar-based custom sticker based on the other person's generated avatar.

In operation 1940, the processor 120 may be configured to apply the other person's generated avatar to the other person's profile stored in the electronic device.

In operation 1950, the processor 120 may transmit information of the other person's avatar to the other person's electronic device through a communication module. For example, the processor 120 may output, to a display screen, guide information notifying of whether to transmit information of the other person's avatar to the other person's electronic device, and may transmit the other person's avatar information to the other person's electronic device in response to the user's transmission approval request.

In some embodiments, operation 1950 may be omitted.

In some embodiments, in operation 1950, in the case where the processor 120 generates a custom sticker based on the other person's avatar, the processor 120 may transmit the custom sticker generated based on the other person's avatar to the other person's electronic device.

In operation 1960, the processor 120 may determine whether to update the other person's avatar by determining whether change information for the other person's generated avatar is detected through gallery database analysis. In operation 1970, when the other person's avatar needs to be changed, the processor 120 may provide updated information to other person's electronic device.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a display;
a camera module;
a memory; and
a processor,
wherein the processor is configured to:
acquire a selfie image using at least one of the camera module and the memory;
generate a user avatar based on the acquired selfie image;
reprocess the user avatar to generate at least one custom object linked to at least one application of the electronic device; and
output the at least one custom object to an application execution screen during execution of the at least one application.

2. The electronic device of claim 1, wherein the at least one custom object includes a custom sticker or custom emoticon including the user avatar.

3. The electronic device of claim 1, wherein the processor is configured to configure the user avatar as a user profile in response to a profile configuration request input received after generation of the user avatar, and to change information of the at least one application linked to the user profile.

4. The electronic device of claim 1, wherein the processor is configured to:
extract face images, which are recognized to be the same as the selfie image, from a gallery database;
identify, from the extracted face images, whether at least one of a feature point and a face element of a recognized face is changed; and
update the user avatar in response to a change in the feature point or a change in the face element.

5. The electronic device of claim 4, wherein the processor is configured to reconfigure the user profile as the updated user avatar, and to update the generated at least one custom object based on the updated user avatar.

6. The electronic device of claim 5, wherein the at least one custom object is configured by a background layer, an avatar layer, and a text layer, and
wherein the processor is configured to update the at least one custom object by changing a user avatar of the avatar layer.

7. The electronic device of claim 1, wherein the processor is configured to, in response to generation of the custom object, configure an authority to use the at least one custom sticker, for at least one application installed in the electronic device, and to add a custom object call item to a keypad layout and an emoticon call item of the at least one application.

8. The electronic device of claim 1, wherein the processor is configured to generate custom objects in various image format types, to identify an image format type available in each application, and to call a custom object in an image format suitable for each application.

9. The electronic device of claim 1, wherein the processor is configured to: detect a condition in which an avatar-related event schedule or an external environment is changed; in response to the detection, acquire a background image or text information corresponding to the event schedule or external environment changing condition; and generate a new custom object based on the acquired background image or text information.

10. The electronic device of claim 1, wherein the processor is configured to: identify an image of other person, who is recognized a defined number of times of frequency or more, in addition to user recognition, while a gallery database is analyzed; and generate other person avatar based on the image of other person recognized in the gallery database.

11. A method for operating an avatar-based custom object by an electronic device, the method comprising:
acquiring a selfie image of a user;
generating a user avatar based on the acquired selfie image;
reprocessing the generated user avatar to generate at least one custom object linked to at least one application of the electronic device; and
providing, to an application execution screen, the at least one custom object generated based on the user avatar in response to a request from the user during execution of the at least one application of the electronic device.

12. The method of claim 11, wherein the at least one custom object includes a custom sticker or custom emoticon including the user avatar, and
wherein the generating of the user avatar further comprises:
outputting guide information for identifying whether a profile and an authority to use the custom object are configured;
configuring the user avatar as a user profile in response to an input for approving the identification; and
changing information of at least one application linked to the user profile.

13. The method of claim 12, wherein the configuring of the user avatar as the user profile further comprises:
in response to the input for approving the identification, configuring an authority to use such that the generated at least one custom object is to be used; and
performing control to add a custom object call item to a keypad layout and an emoticon call item of the at least one application of the electronic device.

14. The method of claim 13, wherein the providing of the at least one custom object to the application execution screen further comprises:
receiving an input for selecting the custom object call item included in the keypad layout and the emoticon call item of the application of the electronic device;
in response to the input for selection, outputting the at least one custom object to the application execution screen; and
in response to selection of the output custom object, executing a function of an application related to the custom object.

15. The method of claim 11, wherein the generating of the at least one custom object comprises generating a plurality of identical custom stickers in various image format types.
